(19) United States
(12) Patent Application Publication
(10) Pub. No.: US 2007/0076551 A1
(43) Pub. Date: Apr. 5, 2007

(54) DATA WRITE METHOD AND OPTICAL DISC APPARATUS

(76) Inventor: Shigeru SHIMAKAWA, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/464,033

(22) Filed: Aug. 11, 2006

(30) Foreign Application Priority Data
Sep. 30, 2005 (JP) 2005-288694

(51) Int. Cl. G11B 7/12

(52) U.S. Cl. 369/47.53

(57) ABSTRACT

A data writing method includes recording test data to a test writing area of an optical disc at a plurality of test recording power values, reproducing the test data, obtaining an asymmetry values for each the test recording power values on the basis of reproduction signals of the test data, obtaining a recording power value characteristics of the asymmetry values, determining a recording power value according to the recording power value characteristics, writing a write data into a program area of the optical disc on the basis of the recording power value, interrupting writing the write data, reproducing at least part of recorded written data before the interruption, obtaining an asymmetry value on the basis of reproduction signals of the recorded written data, updating the recording power value according to the asymmetry value, and resuming writing the write data from the interrupted position according to the recording power value.

### CROSS-REFERENCE TO RELATED APPLICATIONS

This application is based upon and claims the benefit of priority from prior Japanese Patent Application No. 2005-288694, filed Sep. 30, 2005, the entire contents of which are incorporated herein by reference.

### BACKGROUND OF THE INVENTION

1. Field of the Invention

The present invention relates to a data write method and an optical disc apparatus for calibrating a recording power value in writing data into an optical disc.

2. Description of the Related Art

When data is written into an optical disc, irradiation intensity of a laser beam greatly affects the reliability of written data. Accordingly, in order to improve the reliability of written data, it is necessary to control the irradiation intensity (recording power value) of the laser beam.

In order to control the recording power value, optimum power calibration (OPC) is performed before data is written into the optical disc. This OPC is a control for setting an optimum recording power value.

In the OPC, test data is written into a power calibration area (PCA) arranged in the optical disc at a plurality of recording power values. From reproduction signals of the written test data, βvalue is obtained for each recording power value.

By obtaining recording power value characteristics of the β value, and then obtaining a recording power value to become a target β value from the recording power value characteristics, the obtained recording power value is made an appropriate recording power value.

However, while data is written, the temperature of the optical disc increases due to the laser beam irradiated, and the optimum writing power value changes. For this reason, a technique for calibrating a recording power value during data write has been disclosed in Jpn. Pat. Appln. KOKAI Publication No. 2003-168214. In the Jpn. Pat. Appln. KOKAI Publication No. 2003-168214, a value called B level is obtained on the basis of reflected light from an optical disc while data is written. Then, according to the relation between the B level and the β value, the recording power value is controlled.

In an optical disc apparatus, developments are now made to attain higher speeds of write speeds to meet users' needs. However, along the trends toward higher speeds, it has become difficult to appropriately obtain the relation between the B level change amount and the recording power by the method of the prior art, leading to insufficient precision of recording power value control, which has been a problem with the prior art. Further, along the diversified kinds and specifications of optical discs, it has become further difficult to maintain the recording quality level. Particularly, in the case of a write-once optical disc, its wavelength sensitivity fluctuates with temperature changes, and therefore, the recording power control has become an important factor to determine the recording quality level.

### BRIEF SUMMARY OF THE INVENTION

A data writing method according to one aspect of the present invention comprises recording test data to a test writing area of an optical disc at a plurality of test recording power values, reproducing the test data recorded in the optical disc, obtaining an asymmetry values for each the test recording power values on the basis of reproduction signals of the test data, obtaining a recording power value characteristics of the asymmetry values, determining a recording power value according to the recording power value characteristics, writing a write data into a program area of the optical disc on the basis of the recording power value, interrupting writing the write data, reproducing at least part of recorded written data before the interruption, obtaining an asymmetry value on the basis of reproduction signals of the recorded written data, updating the recording power value according to the asymmetry value, and resuming writing the write data from the interrupted position according to the recording power value.

### BRIEF DESCRIPTION OF THE SEVERAL VIEWS OF THE DRAWING

FIG. 1 is a diagram showing a configuration of an optical disc apparatus according to an embodiment of the present invention;

FIG. 2 is a flow chart showing procedures of a data write process using the optical disc apparatus shown in FIG. 1;

FIGS. 3A and 3B are views each showing recording power values to addresses; and

FIG. 4 is a graph showing the relation between βvalue and a recording power value.

### DETAILED DESCRIPTION OF THE INVENTION

An embodiment according to the present invention will be illustrated in more details with reference to the accompanying drawings hereinafter.

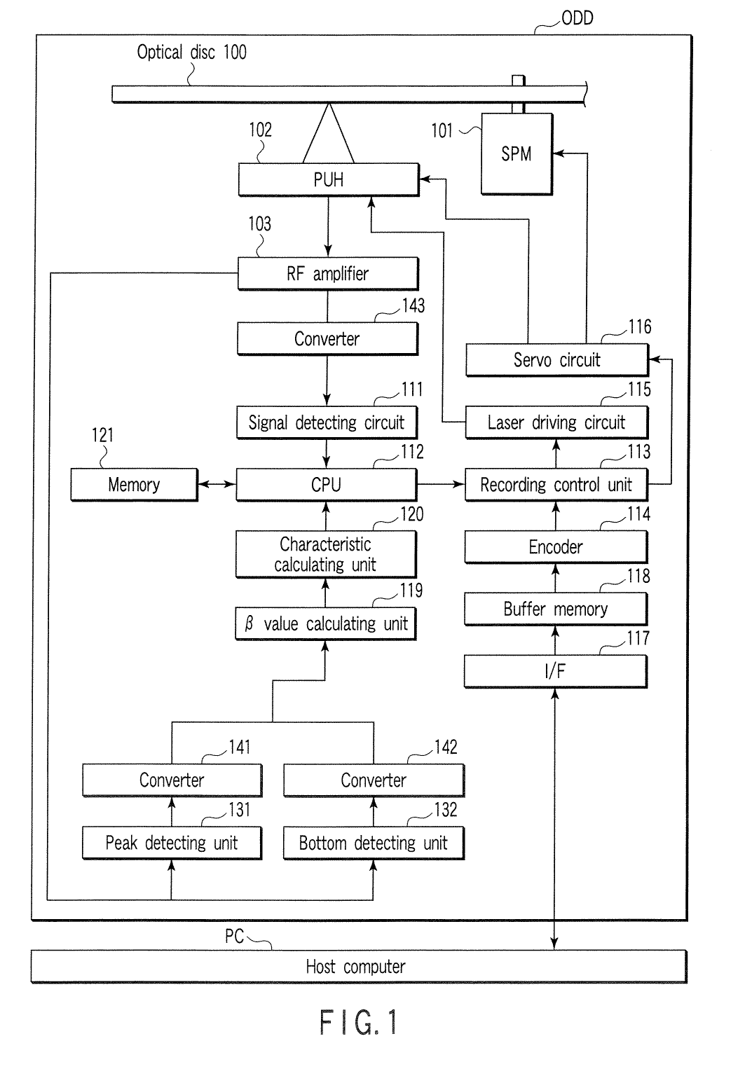

FIG. 1 is a block diagram showing an outline of an optical disc apparatus ODD according to an embodiment of the invention.

The optical disc apparatus ODD includes a spindle motor (SPM) 101 which rotates an optical disc 100, a pickup head 102, an RF amplifier 103, a signal detecting circuit 111, a CPU 112, a recording control circuit 113, an encoder 114, an Laser driving circuit 115, a servo circuit 116, an interface (I/F) unit 117, a buffer memory 118, a β value calculating unit 119, a characteristic calculating unit 120, a memory 121, a peak detecting unit 131, a bottom detecting unit 132, and A/D converters 141 to 143. The pickup head 102 is constituted of a laser diode, an optical system such as an objective lens etc., a focusing actuator, a tracking actuator, a photo detector, a lens position sensor, and the like.

Various programs and various items of data are stored into the memory 121 for using the CPU 112.

To a recording surface of the rotating optical disc 100, a laser beam ejected from the laser diode of the pickup head (PUH) 102 is irradiated, and thereby data is recorded/reproduced. When the reproduce operation, the light reflected from the optical disc 100 is detected by the photo detector of the pickup head 102, and is converted into electric signals.

Readout signals of the pickup head 102 are amplified by the RF amplifier 103. The signals amplified by the RF amplifier 103 are input into the signal detecting circuit 111, the peak detecting unit 131, and the bottom detecting unit 132.

In the signal detecting circuit 111, wobble components are extracted from the input signals. The signal detecting circuit 111 detects a track address of the optical disc 100 having the laser beam irradiated thereon, on the basis of the extracted wobble components, and outputs the track address to the CPU 112. The CPU 112 recognizes the radial recording position of the optical disc 100 from the input address, and outputs a control signal corresponding to the recording position to the recording control circuit 113.

When the data recording operation, data D1 given sequentially from a host computer PC is taken in via the interface unit 117, and stored sequentially into the buffer memory 118. The encoder 114 modulates the data stored into the buffer memory 118 according to the format of the optical disc, for example, according to the eight fourteen modulation (EFM) format in the case of a CD. Then, the encoder 114 outputs the modulated signals to the recording control circuit 113.

The recording control circuit 113 outputs driving control signals to the laser driving circuit 115 and the servo circuit 116 on the basis of the modulated signal from the encoder 114 and the control signal from the CPU 112. The servo circuit 116 controls the rotation of the spindle motor 101, and sets the position of the pickup head 102 at an appropriate position. The laser driving circuit 115 supplies electricity to the laser diode of the pickup head 102 on the basis of the driving control signal, and irradiates a laser beam from the laser diode to the optical disc 100.

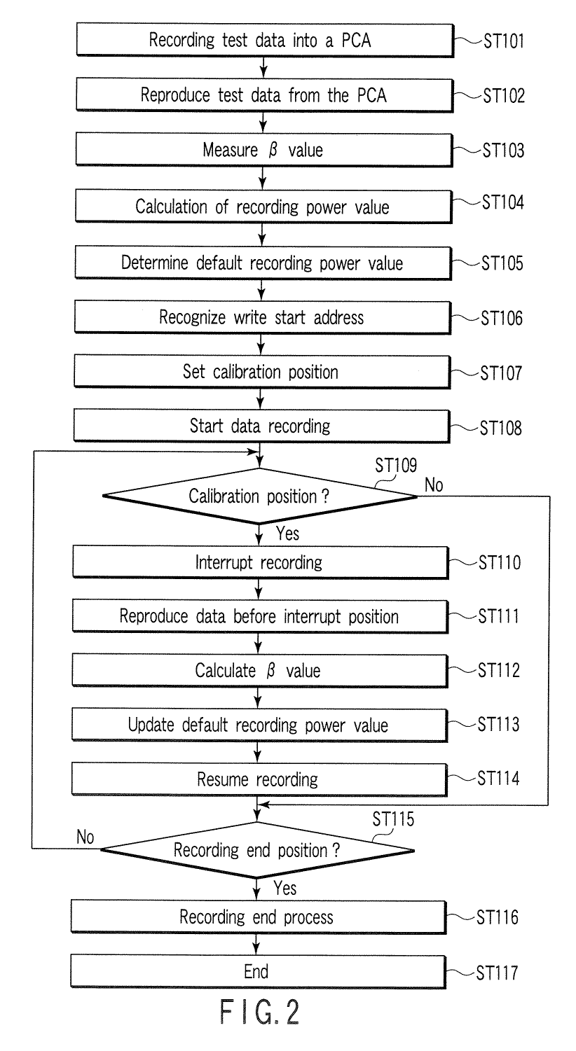

The operation procedures to record data into the optical disc 100 in the optical disc apparatus ODD shown in FIG. 1 will be explained with reference to the flow chart in FIG. 2.

First, the CPU 112 notifies the recording control circuit 113 of the recording speed according to a value designated by a recording command sent from the host computer PC. Next, the CPU 112 acquires an ID number recorded in the optical disc 100 into which data is recorded, and recognizes the kind of the optical disc 100 from the ID number.

Then, the CPU 112 selects a start recording power value and a step value corresponding to the recording speed from a table stored in the memory 121.

The CPU 112 changes the recording power value in 15 steps in unit of the step value from the selected start recording power value, and records test data into a power calibration area (PCA) (test write area) of the optical disc 100 (step ST101).

Next, the test data recorded in the PCA of the optical disc 100 is reproduced (step ST102). At reproduction, an RF signal corresponding to the reflected light from the optical disc 100, the light having been received by the pickup head 102, is input into the RF amplifier 103. The RF amplifier 103 amplifies the input RF signal. The amplified RF signal is input to the peak detecting unit 131 and the bottom detecting unit 132.

Next, β value (asymmetry value) is calculated for each 15 steps recording power value. The calculation of the β value will be explained hereinafter. As described above, the RF signal corresponding to the reflected light from the optical disc 100, the light having been received by the optical pickup, is input into the RF amplifier 103, and the RF signal amplified by the RF amplifier 103 is supplied to the peak detecting unit 131 and the bottom detecting unit 132. The peak detecting unit 131 detects a peak value of the RF signal, and supplies it to the A/D converter 141. The A/D converter 141 converts the supplied peak value (A) into a digital signal and supplies it to the β: value calculating unit 119. In the same manner, the bottom detecting unit 132 detects a bottom value (B) of the RF signal, and supplies it to the A/D converter 142, and the A/D converter 142 converts the supplied bottom value into a digital signal and supplies it to the β value calculating unit 119.

The β value calculating unit 119 calculates a βvalue for each 15 steps recording power value according to the input peak value (A) and bottom value (B), and supplies the calculation result to the characteristic calculating unit 120. The β value is calculated by use of the following expression.
β=(A+B)/(A−B)

Next, the characteristic calculating unit 120 calculates the recording power value characteristic of the β value from the β value obtained for each 15 steps recording power value (step ST104). The characteristic calculating unit 120 calculates an approximate expression showing the relation between the recording power value and the β value as the characteristic, and supplies the approximate expression to the CPU 112.

The CPU 112 reads a target β value corresponding to the recording speed recorded in the memory 121, and determines an optimum default recording power value by use of the supplied approximate expression (step ST105). The optimum default recording power value is stored into the memory 121, and supplied to the recording control circuit 113.

The CPU 112 recognizes a write start address of the optical disc 100 (step ST106). Then, the CPU 112 sets a calibration point for each predetermined block from the write start address (step ST107).

The CPU 112 instructs the recording control circuit 113 to start data write from the write start address in the program area of the optical disc 100 by use of the supplied the optimum default recording power value (step ST108).

During recording, a control signal corresponding to the recording position is supplied from the CPU 112 to the recording control circuit 113. The recording control circuit 113 determines whether the recording position is the calibration position set in step 107 or not (step ST109). If the recording position is the calibration position, recording is interrupted (step ST110).

The CPU 112 reproduces blocks from the position of a predetermined number of blocks before the position where recording is interrupted to the position where recording is interrupted (step ST111). Meanwhile, the number of blocks to be reproduced herein may be the number of blocks enough to obtain sufficient signals for calculating the β value.

In the same manner as in step ST103, the CPU 112 causes the β value calculating unit 119 to calculate the β value from the reproduction signal (step ST112). The CPU 112 causes the recording power value characteristics of the β value calculated in step ST112 and the β value calculated in step ST104, the optimum recording power value is obtained, and the optimum default recording power value recorded in the memory 121 is updated (step ST113).

Herein, a method of obtaining the optimum recording power value again will be explained. FIG. 4 is a graph showing the relation between the β value (%) and the recording power value POWER (mW) as an example.

In the case of calculating the recording power value characteristic by use of the PCA in step ST104, linear interpolation of the β value data at several points before and after a target value of β value (for example β=0%) is performed from the relation of the βvalue and the recording power value shown in FIG. 4. Thereby, the inclination of the change amount of the βvalue can be obtained, and the inclination (σ) becomes to show the recording power value characteristic.

The calculation of the optimum recording power value in step ST113, that is, the calibration of the default recording power value is performed on the basis of the following calculation expression by use of the βvalue obtained by interrupting data write in the program area, and the above recording power value characteristic (σ) obtained in the PCA area:
P′₀P₀+σ×β×a
wherein, P′₀ is the recording power value after calibration, and P₀ is the default recording power value. Meanwhile, a is a constant for making the change amount moderate in the case of avoiding a rapid change in the recording power value, and may be set arbitrarily.

In calibrating the recording power value, it is preferable to perform the calibration by use of the βvalue obtained by interrupting data write, and the recording power value characteristic obtained at test recording. However, for an easier operation, a predetermined coefficient may be used in place of the recording power value characteristic obtained at test recording. Further, it may be troublesome to detect the recording power value by changing it in unit of step like in test recording. However, the recording power value characteristic may be calculated again from the β value obtained by interrupting data write, and may be used in place of the recording power value characteristic obtained at test recording.

Next, the CPU 112 instructs the recording control circuit 113 to resume recording from the position where recording has been interrupted by use of the data stored in the buffer memory 118 (step ST114). The portion to interrupt data write and resume recording is same as the prior art to interrupt/resume recording in order to avoid buffer under run.

After resuming recording (step ST115), or when it is determined that the recording position is not the calibration position in step ST109, it is determined whether or not the recording position is the end position (step ST115). If the write position is not the end position, recording is continued, and the steps ST109 to ST115 are repeated. If the write position is the end position, a recording end processes such as closing the session is performed (step ST116), and the recording is completed (step ST117).

According to the recording method of the present embodiment, recording operation is stopped during recording data, data that has been written just before is reproduced, the β value is obtained, and the recording power value is calibrated, whereby the calibration precision is improved, and the recording quality level is improved.

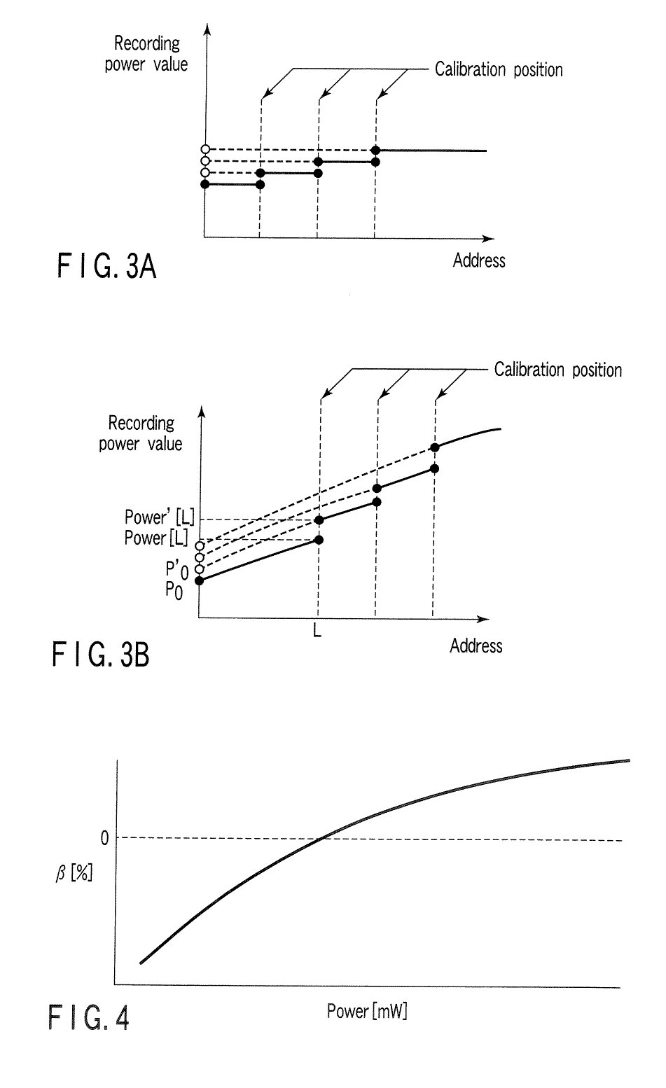

The conditions in which the optimum recording power value is changed according to the aforementioned recording method are shown in FIGS. 3A and 3B. FIG. 3A is a view showing a recording power value with respect to an address in the case of a constant linear velocity (CLV) recording method in which recording is performed by making a linear velocity constant, and FIG. 3B is a view showing a recording power value with respect to an address in the case of a constant angular velocity (CAV) recording method in which recording is performed by making a rotation velocity constant. In FIGS. 3A and 3B, the solid line represents the recording power value used in recording data.

In the case of the CLV recording method, the linear velocity is constant, and therefore, the recording power value is constant irrespective of recording positions if calibration is not performed. In the case of the CAV recording method, however, the linear velocity changes, and therefore, the recording power value changes with recording positions. Namely, the default recording power value is multiplied by a velocity coefficient α corresponding to the recording position. When the recording power value is calibrated at calibration in the CAV recording method, it is necessary to calibrate the velocity coefficient α as well. However, in the case of the present embodiment, the setting of the default recording power value registered in the memory 121 is updated. Accordingly, it is possible to calibrate the recording power value by absorbing the displacement of the velocity coefficient that accompanies the change of the linear velocity without changing the velocity coefficient α.

In FIG. 3B, the default recording power value before calibration is defined as P₀, the recording power value before calibration at address L is defined as Power[L] (=P₀×α), the default recording power value after calibration at address L is defined as P′₀, and the recording power value is defined as Power′[L] (=P′₀×α). In the case of the present embodiment, since the setting of the default recording power value is changed, and the velocity coefficient α is not changed, the relation that Power′[L]=Power[L]×(P′₀/P₀) stands.

Further, in the present embodiment, the setting of the position for recording power calibration, that is, the calibration address for interrupted data write is performed. In the case where the recording method is the CLV method, the record linear velocity does not change. Therefore, in consideration of a temperature increase of the optical disc and the like, it is preferable to perform recording power calibration by interrupting recording at a constant address interval (for each constant record data amount), for example, 20 times in recording data from the most inner circumference of the program area of the optical disc to the most outer circumference thereof. In other words, in the case of recording short data in a short time, the temperature of the optical disc does not increase so much, and thus, there is a small change in the optimum recording power value. However, if continuous data write is performed for a long time in the case of long data, the temperature change of the optical disc becomes large, and the change of the optimum recording power value becomes large accordingly. Therefore, by interrupting data write with a predetermined interval, and calibrating the recording power value at every time as in the above embodiment, it becomes possible to maintain and improve the recording quality level.

Because data write is interrupted at a constant address interval as described above, it is possible to calculate the addresses of the interruption positions in prior from the address of the recording start position, and perform the calibration position setting in step ST107.

Meanwhile, as the number of data write interruption operations is made larger, the precision of the recording power value calibration is improved more. However, the data write interruption operations lead to a loss in recording time although the time thereof is extremely small in comparison with the recording time. Therefore, in order to keep the recording capacity as well, it is preferable to limit the number of interruption operations to 10 times through 100 times while recording data from the most inner circumference of the program area of the optical disc to the most outer circumference thereof.

Further, in the case where the recording method is the CAV method, the recording linear velocity changes, and thus, it is preferable to perform recording power calibration at every time when the linear velocity changes by a predetermined amount. For example, at the moment when the linear velocity changes from 1.0-time velocity into 1.5-time velocity, data write is interrupted, and the recording power calibration is performed. Further, every time when the recording linear velocity is 0.5-time changed, data write is interrupted, and the recording power calibration is performed. In the case where data write is interrupted at every 0.5-time change of the recording velocity, the number of interruption operations becomes approximately 20 times in recording data from the most inner circumference of the program area of the optical disc to the most outer circumference thereof in the same manner as in the case of the above CLV recording method.

Furthermore, in the case of the CAV method, the recording power calibration is calibrated before and after the linear velocity set for interruption, namely, before and after the linear velocity reaches, for example, 1.5-time velocity (in this case, the number of interruption operations becomes double the above number). Consequently, it is possible to confirm whether or not the recording power value calibrated before the linear velocity reaches 1.5-time velocity has absorbed the aforementioned displacement of the velocity coefficient, and to calibrate the recording power value in correspondence to the displacement of the velocity coefficient by the calibration after the linear velocity reaches 1.5-time velocity.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

For example, a part or all of the CPU 112, the recording control circuit 113, the encoder 114, the interface (I/F) unit 117, the buffer memory 118 the value calculating unit 119, the characteristic calculating unit 120, and the memory 121 may consist of one processor.

What is claimed is:

1. A data writing method comprising:
recording test data to a test writing area of an optical disc at a plurality of test recording power values;
reproducing the test data recorded in the optical disc;
obtaining an asymmetry values for each the test recording power values on the basis of reproduction signals of the test data;
obtaining a recording power value characteristics of the asymmetry values;
determining a recording power value according to the recording power value characteristics;
writing a write data into a program area of the optical disc on the basis of the recording power value;
interrupting writing the write data;
reproducing at least part of recorded written data before the interruption;
obtaining an asymmetry value on the basis of reproduction signals of the recorded written data;
updating the recording power value according to the asymmetry value; and
resuming writing the write data from the interrupted position according to the recording power value.

2. The data writing method according to claim 1, wherein the updating includes calibrating the recording power value on the basis of the asymmetry value acquired from the reproduction signals of the recorded write data and the recording power value characteristics, and storing the calibrated recording power value in a memory.

3. The data writing method according to claim 1, wherein the updating includes obtaining the recording power value characteristics from asymmetry value acquired from the reproduction signals of the recorded written data,
calibrating the recording power value from the recording power value characteristics, and
storing the calibrated power value in a memory.

4. The data writing method according to claim 1, further comprising,
acquiring a writing start address of the program area, and
setting a calibration address which interrupts data write in advance according to the acquired writing start address, wherein
the interruption of the data write is performed when the writing position reaches the calibration address.

5. The data writing method according to claim 1, wherein the interruption of writing the data is performed when the change of linear velocity at data write exceeds a predetermined change amount.

6. The data writing method according to claim 1, wherein a plurality of the interrupted positions is set for every constant address interval.

7. The data writing method according to claim 1, further comprising setting a plurality of the interrupted positions from a write start address in the program area of the optical disc; and
wherein the reproducing, the obtaining an asymmetry value, and resuming writing the write data are executed at every the interrupted position.

8. The data writing method according to claim 1, wherein the recording power value P′₀ is obtained by the following expression;
P′₀=P₀+σ×β×α,
where P₀ is the default recording power value, σ is the recording power value characteristics of the asymmetry value, and a is a constant.

9. An optical disc apparatus comprising:
a pickup head unit which performs record/reproduce a data, moving a pickup head to an optical disc;
a spindle motor which rotates the optical disc;
a controller which controls the pickup head and the spindle motor to perform the record/reproduce the data, the controller performs recording test data to a test writing area of an optical disc at a plurality of test recording power values, reproduces the test data recorded in the optical disc, obtains a recording power value characteristics of a asymmetry value which is obtained on the basis of reproduction signals of the test data, determines a recording power value according to the recording power value characteristics, writes predetermined a write data into a program area of the optical disc on the basis of the recording power value, interrupts writing the data, reproduces at least part of recorded written data before the interruption, updates the recording power value according to the asymmetry value which is obtained on the basis of reproduction signals of the recorded written data, and resumes writing the write data from the interrupted position according to the recording power value.

10. The optical disc apparatus according to claim 9, wherein the controller calibrate the recording power value on the basis of the asymmetry value acquired from the reproduction signals of the recorded write data, and stores the recording power value in a memory.

11. The optical disc apparatus according to claim 9, wherein the controller obtains the recording power value characteristics from asymmetry value acquired from the reproduction signals of the recorded written data, calibrates the recording power value from the recording power value characteristics, and stores the updated power value in a memory.

12. The optical disc apparatus according to claim 9, wherein the controller sets a plurality of the interrupted positions from a write start address in the program area of the optical disc, and executes the reproducing, the obtaining an asymmetry value, and resuming writing the write data at every the interrupted position.
